(19) United States
(12) Patent Application Publication
(10) Pub. No.: US 2002/0014976 A1
(43) Pub. Date: Feb. 7, 2002

(54) On-vehicle radio communication equipment, a dedicated short range communication system, and on-vehicle radio communication method

(75) Inventor: Yasuharu Yoshida, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC CORPORATION

(21) Appl. No.: 09/921,714

(22) Filed: Aug. 6, 2001

(30) Foreign Application Priority Data
Aug. 7, 2000 (JP) 2000-238797

(51) Int. Cl. G08G 1/00

(52) U.S. Cl. 340/928; 340/10.1

(57) ABSTRACT

This invention provides a communication connection system for dedicated short range communications capable of successfully operating with respect to a service requiring high speed link connection in an on-vehicle equipment capable of receiving a plurality of services. If a reception side of an on-vehicle searches a plurality of radio frequencies corresponding to respective services in a certain repetition cycle, a search frequency of the radio frequency assigned to the service, such as an ETC service, requiring high speed link connection is set high and a search frequency of the radio frequency assigned to the service, such as a various information providing service or a parking lot management service, capable of being executed with low speed link connection is set low.

### BACKGROUND OF THE INVENTION

1. Field of the Invention

The present invention relates to a communication connection system for dedicated short range communications used in an intelligent transport system (to be referred to as “ITS” hereinafter). More specifically, the present invention relates to a dedicated short range communication connection system used in service zones where a plurality of services exist.

2. Description of the Prior Art

In recent years, studies and development have been conducted so as to put various systems regarding the ITS to practical use. Among these systems, an electronic toll collection (to be referred to as “ETC”) system is now being put to practical use.

A communication system used in the ETC system is called a dedicated short range communication system which is a communication system in a very dedicated short range. A plurality of systems to which this dedicated short range communication system is applied and which provides various services have been studied. The systems are expected as systems following the ETC system.

To spread the systems, it is necessary to establish a communication system so that one on-vehicle dedicated short range communication equipment (hereinafter, referred to as “on-vehicle equipment”) can receive a plurality of services. The on-vehicle equipment means herein a radio equipment mounted in a motor vehicle so that the on-vehicle equipment can communicate with fixed roadside dedicated short range communication equipment (hereinafter, referred to as “roadside equipment”) according to the dedicated short range communication system and to receive a plurality of items of service information. Also, the roadside equipment means herein a fixed base station equipment provided on the roads or the like so that the roadside equipment can communicate with on-vehicle equipment mounted in traveling motor vehicles according to the dedicated short range communication system and to transmit a plurality of items of service information. Each roadside equipment transmits and receives data signals relating to service information and control signals relating to various controls to and from a host station.

A system is now being studied which allows an on-vehicle equipment entering each service zone to have communication suited for the service of the zone and to receive the service. One of the problems to be solved to realize this system is a connection method securing access time suited for each service.

FIG. 3 is a block diagram schematically showing the configuration of a conventional ETC dedicated short range communication system. As shown in FIG. 3, this system comprises a roadside equipment 1, an on-vehicle equipment 2, a motor vehicle 3 and an ETC zone 4. The roadside equipment 1 is disposed in the ETC zone 4. The ETC zone 4 represents a service zone in which the on-vehicle equipment 2 can communicate with the roadside equipment 1. When the on-vehicle equipment 2 mounted in the motor vehicle 3 enters the ETC zone 4, the on-vehicle equipment 2 can receive an ETC service by communicating with the roadside equipment 1. Also, the roadside equipment 1 is connected to a host station and the equipment 1 transmits information transmitted and received to and from the on-vehicle equipment 2 to the host station.

The roadside equipment 1 transmits a signal wave having a radio frequency F1 or F2 which has been subjected to amplitude shift keying (to be referred to as “ASK” hereinafter) and the on-vehicle equipment 2 receives the signal wave. The on-vehicle equipment 2 transmits a signal wave having a radio frequency F1′ or F2′ which has been subjected to ASK and the roadside equipment 1 receives the signal wave. In this case, two waves having radio frequencies F1 and F2 are assigned to the transmission radio frequencies of the roadside equipment 1, so that the on-vehicle equipment 2 is required to carry out a processing for recognizing the two waves.

FIG. 4 describes connection procedures in the radio frequency recognition processing of the on-vehicle equipment 2. As shown in FIG. 4, (a) indicates the reception radio frequency of the on-vehicle equipment 2, (b) indicates the operation of the reception side of the on-vehicle equipment 2 and (c) indicates the contents of the communication between the on-vehicle equipment 2 and of the roadside equipment 1.

As indicated by (a) in FIG. 4, the on-vehicle equipment 2 is set to always repeat the reception radio frequencies F1 and F2 in a certain search repetition period if no link is connected to the on-vehicle equipment 2. For example, when the on-vehicle equipment 2 enters the ETC zone in which the roadside equipment employs F2, the reception side of the on-vehicle equipment 2 carries out operations as indicated by (a) and (b) of FIG. 4. That is, while the reception side of the on-vehicle equipment 2 is searching the radio frequency F1, the on-vehicle equipment 2 cannot demodulate a reception signal, because the reception radio frequency of the on-vehicle equipment 2 differs from the radio frequency F2. As a result, after the passage of the F1 search repetition time, the on-vehicle equipment 2 starts an operation for searching the next signal wave having the radio frequency F2.

Next, while the on-vehicle equipment 2 is searching the radio frequency F2, the reception radio frequency of the on-vehicle equipment 2 is coincident with the radio frequency of the roadside equipment 1, and therefore, the on-vehicle equipment 2 can demodulate a reception signal Then, if the on-vehicle equipment 2 detects a signal specifying a service and can confirm that the signal indicates the ETC service, then the radio frequency is fixed to F2, link connection communication of two or three items is held between the on-vehicle equipment 2 and the roadside equipment 1 so as to establish link connection, and thereafter, the communication of the ETC service starts.

As explained above, according to the conventional communication connection system for dedicated short range communication, if the on-vehicle equipment mounted in the motor vehicle running in a service zone is to receive a service, the number of radio frequencies transmitted from the roadside equipment increases as the number of services provided to the on-vehicle equipment 2 increases, and the on-vehicle equipment repeatedly carries out the operation for searching radio frequencies. This disadvantageously requires long time to complete communication connection.

In other words, if the number of radio frequencies corresponding to services increases, then the repetition number of searches for performing both demodulation and recognition process in order to tune the reception side of the on-vehicle equipment to the radio frequency transmitted from roadside equipment increases, whereby the search time is prolonged.

In case of the ETC service, in particular, it is necessary to ensure collecting tolls from motor vehicles which are traveling. Due to this, as compared with the other services, the ETC service requires high speed link connection. This means that a link connection failure has greater influence on the ETC service than the other services.

### SUMMARY OF THE INVENTION

The present invention has been made in view of the above-stated disadvantages. It is, therefore, an object of the present invention to provide a communication connection system for dedicated short range communication capable of successfully operating in respect of a service requiring high speed link connection in an on-vehicle equipment capable of receiving a plurality of services.

According to a first aspect of the present invention, there is provided an on-vehicle dedicated short range communication equipment comprising:

searching means for performing search for radio frequencies used by a roadside dedicated short range communication equipment with which the on-vehicle dedicated short range communication equipment is going to have a dedicated short range communication; and establishing means for establishing a link for the dedicated short range communication with the roadside dedicated short range communication equipment at the searched frequencies, wherein the searching means performs the search by cyclically switching radio frequencies from one to another while keeping a ratio that radio frequencies for a first type of communication is searched for larger than a ratio that a radio frequencies for a second type of communication is searched for.

In the on-vehicle dedicated short range communication equipment, the first type of communication may be a communication requiring high-speed link establishment, and the second type of communication may be a communication not requiring high-speed link establishment.

In the on-vehicle dedicated short range communication equipment, the searching means may keep the ratio that the radio frequencies for the communication requiring high-speed link establishment is searched for larger than the ratio that the radio frequencies for the communication not requiring high-speed link establishment is searched for by increasing the number of times that the radio frequencies for the communication requiring high-speed link establishment is searched for.

In the on-vehicle dedicated short range communication equipment, the searching means may switch demodulation method when switching radio frequencies.

In the on-vehicle dedicated short range communication equipment, radio frequencies used by roadside dedicated short range communication equipments may be divided into groups, the group may be designated before the searching means starts the search, and the searching means may perform the search by cyclically switching radio frequencies in the designated group.

In the on-vehicle dedicated short range communication equipment, a part of a group may overlap a part of another group.

According to a second aspect of the present invention, there is provided a dedicated short range communication system, comprising: the on-vehicle dedicated short range communication equipment of the first aspect; and roadside dedicated short range communication equipments.

According to a third aspect of the present invention, there is provided an on-vehicle dedicated short range communication method comprising: a searching step for performing search for radio frequencies used by a roadside dedicated short range communication equipment with which the on-vehicle dedicated short range communication equipment is going to have a dedicated short range communication; and a establishing step for establishing a link for the dedicated short range communication with the roadside dedicated short range communication equipment at the searched frequencies, wherein the searching step performs the search by cyclically switching radio frequencies from one to another while keeping a ratio that radio frequencies for a first type of communication is searched for larger than a ratio that a radio frequencies for a second type of communication is searched for.

In the on-vehicle dedicated short range communication method, the first type of communication may be a communication requiring high-speed link establishment, and the second type of communication may be a communication not requiring high-speed link establishment.

In the on-vehicle dedicated short range communication method, the searching step may keep the ratio that the radio frequencies for the communication requiring high-speed link establishment is searched for larger than the ratio that the radio frequencies for the communication not requiring high-speed link establishment is searched for by increasing the number of times that the radio frequencies for the communication requiring high-speed link establishment is searched for.

In the on-vehicle dedicated short range communication method, the searching step may switch demodulation method when switching radio frequencies.

In the on-vehicle dedicated short range communication method, radio frequencies used by roadside dedicated short range communication equipments may be divided into groups, the group may be designated before the searching means starts the search, and the searching step may perform the search by cyclically switching radio frequencies in the designated group.

In the on-vehicle dedicated short range communication method, a part of a group may overlap a part of another group.

### BRIEF DESCRIPTION OF THE DRAWINGS

FIG. 1 is a block diagram showing the types of services employing an ETC dedicated short range communication system according to the present invention;

FIG. 2 shows radio frequency search frequency setting methods;

FIG. 3 is a block diagram schematically showing a conventional ETC dedicated short range communication system; and

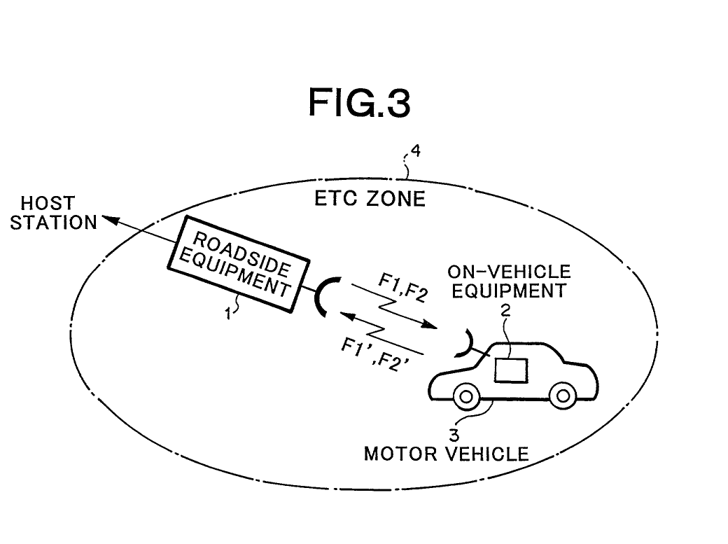

FIG. 4 is an explanatory view for connection procedures in the radio frequency recognition processing carried out by an on-vehicle equipment.

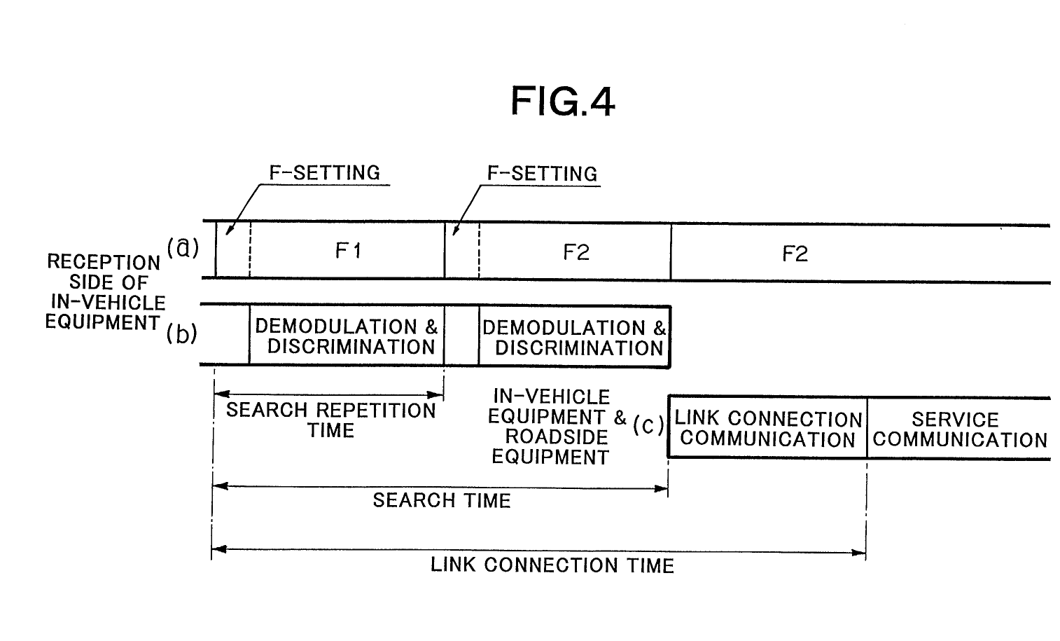

### DETAILED DESCRIPTION OF THE INVENTION

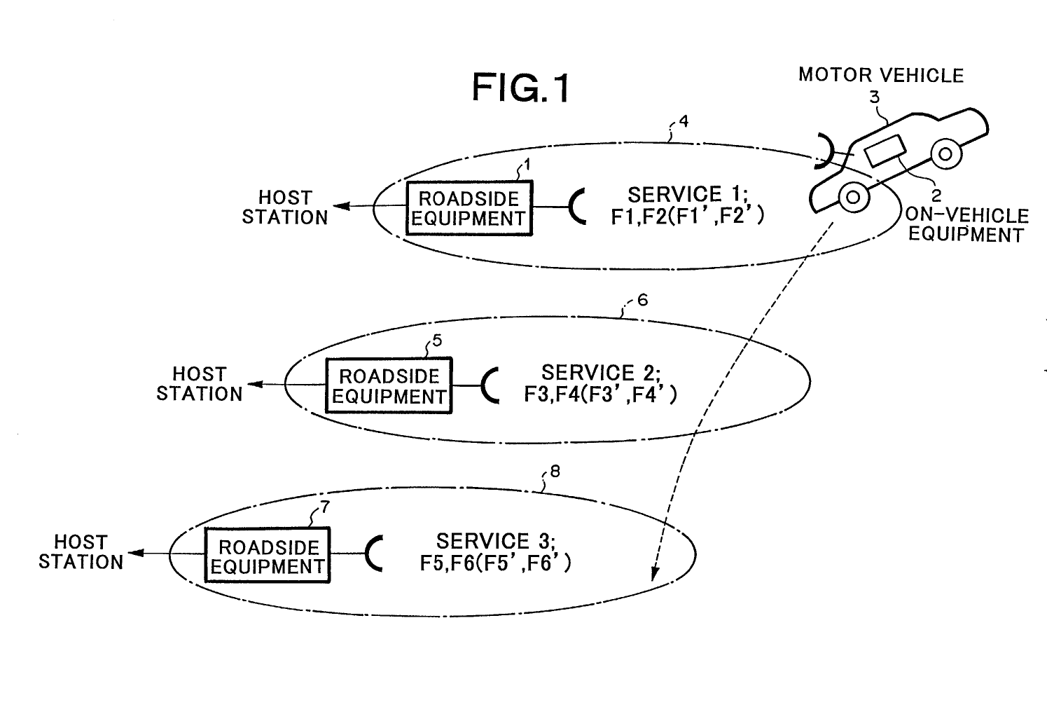

The embodiment of the present invention will be described hereinafter with reference to the accompanying drawings. FIG. 1 is a block diagram showing the types of services employing an ETC dedicated short range communication system according to the present invention. As shown in FIG. 1, a service zone 4 is a zone for providing an ETC service (service 1) assigned with radio frequencies F1 and F2 (and F1′ and F2′), at which frequencies a roadside equipment 1 transmits signal waves. A service zone 6 is a zone providing a various information providing service (service 2) assigned with radio frequencies F3 and F4 (or F3′ and F4′), at which frequencies a roadside equipment 5 transmits signal waves. A service zone 8 is a zone for providing a parking lot management service (service 3) assigned with radio frequencies F5 and F6 (or F5′ and F6′), at which frequencies a roadside equipment 7 transmits signal waves. The features of the respective services are as follows: The service 1 requires high speed link connection. The services 2 and 3 accept low speed link connection.

In addition, the roadside equipment 1, 5 and 7 are connected to a host station. An on-vehicle equipment 2 mounted in a motor vehicle 3 can transmit and receive signal waves having radio frequencies F1 to F6 (F1′ to F6′) subjected to ASK and deal with the above-stated three services. The motor vehicle 3 sequentially enters the service zones 4, 6 and 8 and the reception side of the on-vehicle equipment 2 performs frequency searches between F1 and F6 to receive the services 1 to 3.

Namely, when the motor vehicle 3 enters the service zone 4 providing a service at the radio frequency F1, the reception side of the on-vehicle equipment 2 searches a reception frequency. If the search hits on the radio frequency F1, the on-vehicle equipment 2 can demodulate a transmission signal from the roadside equipment 1 and the on-vehicle equipment 2 receives service information, whereby the service starts. The similar operation is carried out if the motor vehicle 3 enters the other service zones.

As can be seen, after the reception side of the on-vehicle equipment 2 sequentially searches F1 to F6, link connection communication is established and link connection is completed. Therefore, link connection time in this embodiment is, on the average, about three times as long as link connection time when two radio frequencies F1 and F2 are used as described in “Description of the Prior Art” part. As a result, if the communication connection system of this type is employed for the ETC service, such as the service 1, which requires high speed link connection, there is a possibility that link connection cannot be established.

In order to avoid the above problem, when searching a plurality of radio frequencies corresponding to the respective services in a certain search repetition cycle, the reception side of the on-vehicle equipment 2 increases the number of times to search radio frequencies assigned to a service (e.g., ETC service) requiring high speed link connection and decreases the number of times to search radio frequencies assigned to a service (e.g., various information providing service or a parking lot management service) which can be executed with low speed link connection.

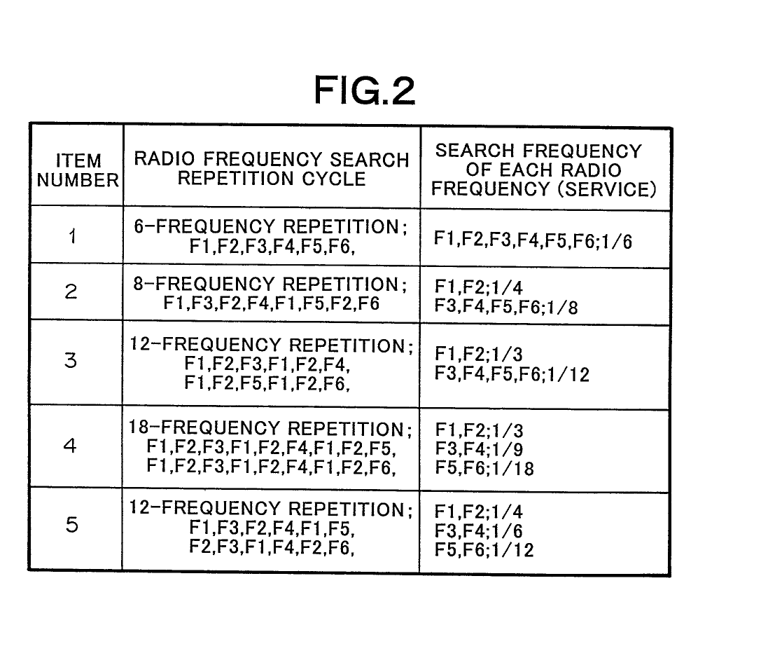

FIG. 2 shows radio frequency search repetition frequency setting methods according to the present invention. As shown in FIG. 2, the radio frequencies F1 and F2 are assigned to the ETC service, the radio frequencies F3 and F4 are assigned to the various information providing service and the radio frequencies F5 and F6 are assigned to the parking lot management service. The features of the respective services are as follows: The service 1 assigned the radio frequencies F1 and F2 requires highest speed link connection, followed by the service 2 assigned the radio frequencies F3 and F4 and the service 3 assigned the radio frequencies F5 and F6. It, therefore, follows that the services assigned the radio frequencies F3 to F6 can be executed at low speed link connection.

Item 1 in FIG. 2 shows a case of a conventional method in which a 6-frequency search repetition cycle is provided and in which the search repetition frequencies of respective radio frequencies are equally 1/6. An Item 2 and the below in FIG. 2 show radio frequency search frequency setting methods according to the present invention.

First, an embodiment of item 2 in FIG. 2 shows a case of an 8-frequency search repetition cycle. In this embodiment, among 6 radio frequencies corresponding to the respective services, two radio frequencies are increased by only once in the radio frequency search repetition cycle, thereby providing an 8-frequency search repetition cycle as a whole. That is to say, the radio frequencies F1 and F2 are searched twice, respectively, thereby making it possible to increase the occurrence frequency of each of F1 and F2 as compared with that in the conventional method. Instead, the occurrence frequency of each of F3 to F6 which remain searched once is decreased as compared with that in the conventional method. In other words, by making search time for the radio frequency which does not require high speed search slower, search time for the radio frequency which requires high speed search is made faster. As a result, the occurrence frequency of each of F1 and F2 in one cycle is set at ¼ while that of each of F3 to F6 is set lower to ⅛. In addition, search time for each of F1 and F2 is ⅔ times as long as the conventional method and search time for each of F3 to F6 is 4/3 times as long as the conventional method.

An embodiment of item 3 in FIG. 2 shows a case of a 12-frequency search repetition cycle. In this embodiment, among six radio frequencies corresponding to the respective services, two radio frequencies are increased by three times in the radio frequency search repetition cycle, respectively, thereby providing a 12-frequency search repetition cycle as a whole. That is, the radio frequencies F1 and F2 are searched four times, respectively, thereby making it possible to set the occurrence frequency of each F1 and F2 far higher than that in the conventional method. Instead, the occurrence frequency of each of F3 to F6 which remain searched once is set lower than that in the conventional method. As a result, the occurrence frequency of each of F1 and F2 in one cycle is ⅓ and that of each of F3 to F6 in one cycle is 1/12. In this case, search time for each of F1 and F2 is a half times as long as the conventional method and search time for each of F3 to F6 is two times as long as the conventional method.

An embodiment of item 4 in FIG. 2 shows a case of dividing occurrence frequencies into three groups. The item 4 shows a case of an 18-frequency search repetition cycle. If there are six radio frequencies corresponding to the respective services, the radio frequencies F1 and F2 are searched six times, respectively, the radio frequencies F3 and F4 are searched twice, respectively, and the radio frequencies F5 and F6 are searched once, respectively in one cycle. As a result, the occurrence frequency of each of F1 and F2 in one cycle is ⅓, that of each of F3 and F4 is 1/9 and that of each of F5 and F6 is 1/18. In this case, search time for each of F1 and F2 is a half times as long as the conventional method and search time for each of F5 and F6 is theee times as long as the conventional method.

An embodiment of item 5 in FIG. 2 shows a case of dividing occurrence frequencies into three groups as in the case of the item 4 embodiment. The item 5 shows a case of a 12-frequency search repetition cycle. If there are six radio frequencies corresponding to the respective services, the radio frequencies F1 and F2 are searched three times, respectively, the radio frequencies F3 and F4 are searched twice, respectively, and the radio frequencies F5 and F6 are searched once, respectively in one cycle. As a result, the occurrence frequency of each of F1 and F2 in one cycle is ¼, that of each of F3 and F4 in one cycle is ⅙ and that of each of F5 and F6 in one cycle is 1/12. In this case, search time for each of F1 and F2 is ⅔ times as long as the conventional method, search time for each of F3 and F4 is the same as the conventional method, and search time for each of F5 and F6 is two times as long as the conventional method.

It is noted that the present invention is not limited to the above-stated embodiments. In the embodiments above, the same modulation system is employed for modulating frequencies assigned to the respective services. There are cases where some services requires increased transmission capacity while requiring low speed link connection. In these cases, it is possible to adopt a high efficiency modulation system such as QPSK or 16 QAM and individual modulation systems may be assigned to the respective frequencies. If so, when the reception side of the on-vehicle equipment performs radio frequency searches, the modulation-demodulation systems is switched simultaneously with a radio frequency switching operation.

Further, it is premised in the embodiment described so far that the on-vehicle equipment cannot predict which service zone the on-vehicle equipment enters. For that reason, a method of searching all the radio frequencies corresponding to the respective services and establishing link connection has been described above. However, the following method may be employed. To decrease the number of frequency searches to shorten link connection time, a plurality of radio frequencies assigned to the respective services are classified into specific groups in advance, one of the groups is selected either automatically or manually before an on-vehicle equipment enters a service zone, and only the radio frequencies for each group are searched.

For example, six radio frequencies corresponding to the respective services described so far and shown in FIG. 1, are classified as group (a), and newly added frequencies corresponding to the respective services are classified as group (b). A service zone for the group (a) is established in a range A and a service zone for the group (b) is established in a range B. The system transmits a signal for selecting a reception mode to an on-vehicle equipment in advance before the motor vehicle enters these ranges to switch the reception mode either automatically or manually by a motor vehicle driver. By doing so, the system can operate in a group (a) reception mode and search only six radio frequencies in the range A, and the system can operate in a group (b) reception mode and search only four radio frequencies in the range B, thereby advantageously shortening link connection time.

Moreover, in the embodiments for classifying radio frequencies corresponding to the respective services into groups, description has been given while the entire frequencies are divided into groups (a) and (b). Alternatively, some frequencies may fall into two or more groups. Namely, in that case, a service (or services) common among the groups (a) and (b) is (or are) provided.

As explained above, according to the present invention, if the reception side of the on-vehicle equipment searches a plurality of radio frequencies corresponding to the respective services in a certain search repetition cycle, the occurrence frequencies of the radio frequencies are changed to set the search frequency of each radio frequency assigned to a service requiring high speed link connection to be high and set the search frequency of each radio frequency assigned to a service requiring low speed link connection to be low. Hence, the present invention can advantageously and successfully establish communication connection with respect to a plurality of services requiring high speed link connection.

Further, according to the present invention, different modulation systems are used for a part of radio frequencies corresponding to the respective services. If the reception side of the on-vehicle equipment searches radio frequencies, the system controls the reception side of the on-vehicle equipment to switch over to a modulation system corresponding to a certain radio frequency simultaneously with switching over to the certain radio frequency, thereby making it possible to provide various services different in required link connection speed or various services different in transmission capacity.

Moreover, according to the present invention, the system controls the reception side of the on-vehicle equipment to classify a plurality of radio frequencies corresponding to the respective services into specific groups, to select one of the groups either automatically or manually before the on-vehicle equipment enters a service zone and to search only the radio frequencies belonging to the selected group in a certain repetition search cycle, thereby making it possible to shorten link connection time.

What is claimed is:

1. An on-vehicle dedicated short range communication equipment comprising:
searching means for performing search for radio frequencies used by a roadside dedicated short range communication equipment with which the on-vehicle dedicated short range communication equipment is going to have a dedicated short range communication; and
establishing means for establishing a link for the dedicated short range communication with said roadside dedicated short range communication equipment at the searched frequencies,
wherein said searching means performs the search by cyclically switching radio frequencies from one to another while keeping a ratio that radio frequencies for a first type of communication is searched for larger than a ratio that a radio frequencies for a second type of communication is searched for.

2. The on-vehicle dedicated short range communication equipment as set forth in claim 1,
wherein said first type of communication is a communication requiring high-speed link establishment, and
wherein said second type of communication is a communication not requiring high-speed link establishment.

3. The on-vehicle dedicated short range communication equipment as set forth in claim 1,
wherein said searching means keeps the ratio that the radio frequencies for the communication requiring high-speed link establishment is searched for larger than the ratio that the radio frequencies for the communication not requiring high-speed link establishment is searched for by increasing the number of times that the radio frequencies for the communication requiring high-speed link establishment is searched for.

4. The on-vehicle dedicated short range communication equipment as set forth in claim 1,
wherein said searching means switches demodulation method when switching radio frequencies.

5. The on-vehicle dedicated short range communication equipment as set forth in claim 1,
wherein radio frequencies used by roadside dedicated short range communication equipments are divided into groups,
wherein the group is designated before said searching means starts the search, and
wherein said searching means performs the search by cyclically switching radio frequencies in the designated group.

6. The on-vehicle dedicated short range communication equipment as set forth in claim 5,
wherein a part of a group overlaps a part of another group.

7. A dedicated short range communication system, comprising:
the on-vehicle dedicated short range communication equipment as set forth in any one of claims 1 to 6; and
roadside dedicated short range communication equipments.

8. An on-vehicle dedicated short range communication method comprising:
a searching step for performing search for radio frequencies used by a roadside dedicated short range communication equipment with which the on-vehicle dedicated short range communication equipment is going to have a dedicated short range communication; and
a establishing step for establishing a link for the dedicated short range communication with said roadside dedicated short range communication equipment at the searched frequencies,
wherein said searching step performs the search by cyclically switching radio frequencies from one to another while keeping a ratio that radio frequencies for a first type of communication is searched for larger than a ratio that a radio frequencies for a second type of communication is searched for.

9. The on-vehicle dedicated short range communication method as set forth in claim 8,
wherein said first type of communication is a communication requiring high-speed link establishment, and
wherein said second type of communication is a communication not requiring high-speed link establishment.

10. The on-vehicle dedicated short range communication method as set forth in claim 8,
wherein said searching step keeps the ratio that the radio frequencies for the communication requiring high-speed link establishment is searched for larger than the ratio that the radio frequencies for the communication not requiring high-speed link establishment is searched for by increasing the number of times that the radio frequencies for the communication requiring high-speed link establishment is searched for.

11. The on-vehicle dedicated short range communication method as set forth in claim 8,
wherein said searching step switches demodulation method when switching radio frequencies.

12. The on-vehicle dedicated short range communication method as set forth in claim 8,
wherein radio frequencies used by roadside dedicated short range communication equipments are divided into groups,
wherein the group is designated before said searching means starts the search, and
wherein said searching step performs the search by cyclically switching radio frequencies in the designated group.

13. The on-vehicle dedicated short range communication method as set forth in claim 12,
wherein a part of a group overlaps a part of another group.
